(19) United States
(12) Patent Application Publication
(10) Pub. No.: US 2017/0153754 A1
(43) Pub. Date: Jun. 1, 2017

(54) METHOD AND DEVICE FOR OPERATING OBJECT

(71) Applicant: Xiaomi Inc., Beijing (CN)

(72) Inventors: Zhijun CHEN, Beijing (CN); Wendi HOU, Beijing (CN); Fei LONG, Beijing (CN)

(73) Assignee: Xiaomi Inc.

(21) Appl. No.: 15/365,468

(22) Filed: Nov. 30, 2016

(30) Foreign Application Priority Data
Dec. 1, 2015 (CN) 201510862378.7

(51) Int. Cl. G06F 3/041; G06F 3/0484; G06F 3/0488

(52) U.S. Cl. CPC G06F 3/0416; G06F 3/04883; G06F 3/04842; G06F 2203/04104

(57) ABSTRACT

A method for operating an object on a mobile terminal includes: receiving an edge touch signal generated by an edge touch sensor of the mobile terminal; selecting a target operation object on a user interface of the mobile terminal according to the edge touch signal, wherein the user interface includes at least one operation object; and performing a preset operation on the target operation object.

### CROSS-REFERENCE TO RELATED APPLICATIONS

This application is based upon and claims priority to Chinese Patent Application 201510862378.7, filed Dec. 1, 2015, the entire contents of which are incorporated herein by reference.

### TECHNICAL FIELD

The present disclosure generally relates to user interface (UI) technologies, and more particularly, to a method and device for operating an object on a UI.

### BACKGROUND

A user interface usually includes a plurality of operation objects. The operation objects may be application programs, folders, files, menu items, grids and the like.

When a user needs to operate one of the operation objects in the user interface, the user needs to tap or click the operation object so as to select the operation object among the plurality of operation objects. After the user's selection, a terminal performs a preset operation corresponding to the operation object. For example, the terminal can open the object, start the object, or perform other operations relating to the object.

### SUMMARY

In order to address the problem of inconvenience in one-hand operation due to relatively large screen of current mobile terminals, the present disclosure provides a method and device for operation an object. The technical solutions of the present disclosure are as follows.

According to a first aspect of the present disclosure, there is provided a method for operating an object on a mobile terminal. The method includes: receiving an edge touch signal generated by an edge touch sensor of the mobile terminal; selecting a target operation object on a user interface of the mobile terminal according to the edge touch signal, wherein the user interface includes at least one operation object; and performing a preset operation on the target operation object.

According to another aspect of the present disclosure, there is provided a device for operating an object. The device includes a processor and a memory for storing instructions executable by the processor. The processor is configured to: receive an edge touch signal generated by an edge touch sensor of the mobile terminal; select a target operation object on a user interface according to the edge touch signal, wherein the user interface includes at least one operation object; and perform a preset operation on the target operation object.

According to another aspect of the present disclosure, there is provided a non-transitory computer-readable storage medium having stored therein instructions that, when executed by a processor of a mobile terminal, cause the mobile terminal to perform a method for operating an object, the method including: receiving an edge touch signal generated by an edge touch sensor of the mobile terminal; selecting a target operation object on a user interface of the mobile terminal according to the edge touch signal, wherein the user interface includes at least one operation object; and performing a preset operation on the target operation object.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1A is a block diagram of a mobile terminal for implementing a method for operating an object according to an exemplary embodiment of the present disclosure.

FIG. 1B shows a schematic diagram of a mobile terminal for implementing a method for operating an object according to an exemplary embodiment of the present disclosure.

FIG. 1C shows a schematic diagram of a mobile terminal for implementing a method for operating an object according to an exemplary embodiment of the present disclosure.

FIG. 2A is a flowchart illustrating a method for operating an object according to an exemplary embodiment of the present disclosure.

FIG. 2B is a schematic diagram of a mobile terminal for implementing a method for operating an object according to an exemplary embodiment of the present disclosure.

FIG. 3A is a flowchart illustrating a method for operating an object according to an exemplary embodiment of the present disclosure.

FIG. 3B is a schematic diagram of a mobile terminal for implementing a method for operating an object according to an exemplary embodiment of the present disclosure.

FIG. 3C is a flowchart illustrating a method for determining a display region on a user interface according to an exemplary embodiment of the present disclosure.

FIG. 3D is a schematic diagram of a mobile terminal for implementing a method for operating an object according to an exemplary embodiment of the present disclosure.

FIG. 3E is a flowchart illustrating a method for determining a display region on a user interface according to an exemplary embodiment of the present disclosure.

FIG. 4 is a block diagram of a device for operating an object according to an exemplary embodiment of the present disclosure.

FIG. 5 is a block diagram of another device for operating an object according to an exemplary embodiment of the present disclosure.

FIG. 6 is a block diagram of another device for operating an object according to an exemplary embodiment of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

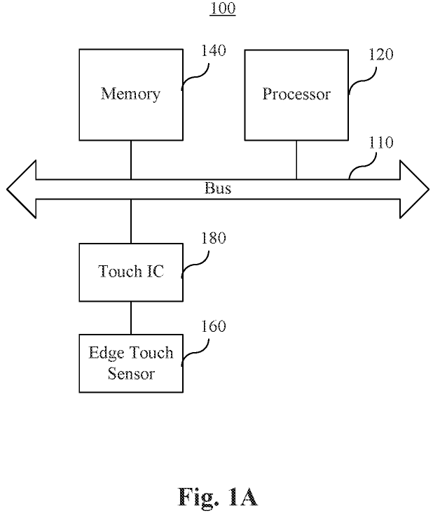

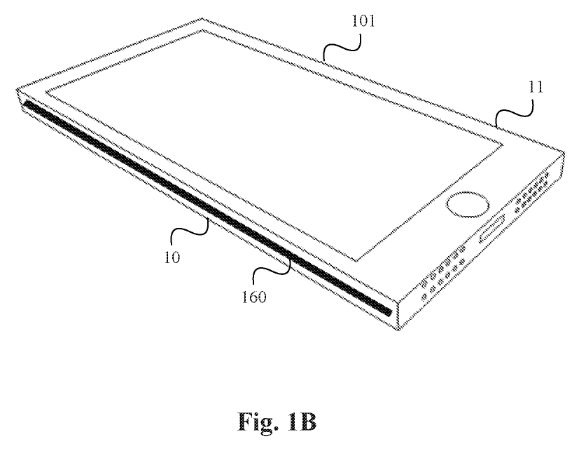

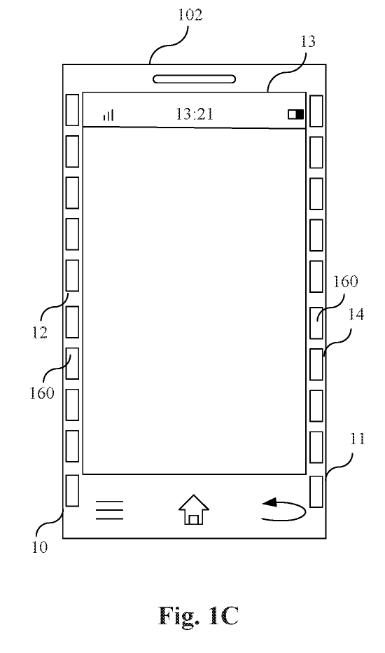

FIG. 1A is a block diagram of a mobile terminal 100 for implementing a method for operating an object, according to an exemplary embodiment of the present disclosure. The mobile terminal 100 can be an electronic device such as a mobile phone, a tablet, an e-book reader and the like. The mobile terminal 100 can include a bus 110, a processor 120, a memory 140, an edge touch sensor 160, and a touch-sensing Integrated Circuit (IC) 180.

The memory 140 is coupled to the processor 120 via the bus 110. The edge touch sensor 160 is coupled to the touch-sensing IC 180, and the touch-sensing IC 180 is coupled to the processor 120 via the bus 110.

The memory 140 stores instructions executable by the processor 120 and preset unlock passwords.

The edge touch sensor 160 is configured to receive edge touch signals.

The edge touch sensor 160 sends the received edge touch signals to the touch-sensing IC 180.

The touch-sensing IC 180 converts the edge touch signals into signals recognizable by the processor 120 and sends the converted signals to the processor 120. In some embodiments, the touch-sensing IC 180 detects the received signals sent from the edge touch sensor 160, and sends the detected results to the processor 120.

The edge touch sensor 160 can be disposed on the periphery of the mobile terminal 100 at, for example, at least one of an upper frame, a lower frame, a left frame, and a right frame of the mobile terminal 100, or disposed at a region between a touch screen of the terminal 100 and at least one of the frames of the terminal 100.

In some embodiments, the mobile terminal 100 have at least one edge touch sensor 160.

In some embodiments, a plurality of edge touch sensors 160 can be, e.g., evenly distributed on the periphery of at least one of the upper frame, the lower frame, the left frame, or the right frame of the terminal 100 in a discrete manner, or disposed at a region between a touch screen of the terminal 100 and at least one of the frames of the terminal 100 in a discrete manner.

In some embodiments, the edge touch sensor(s) 160 can form a stripe shape disposed at the periphery of at least one of the upper frame, the lower frame, the left frame and the right frame of the terminal 100, or disposed at a region between a touch screen of the terminal 100 and at least one of the frames of the terminal 100. For example, the edge touch sensor(s) 160 in the stripe shape can cover the region between the touch screen and one frame.

FIG. 1B shows a schematic diagram of a mobile terminal 101 according to an exemplary embodiment of the present disclosure. An edge touch sensor 160 in a stripe shape can be disposed at least one of the upper frame, the lower frame, the left frame, or the right frame of the terminal 101. As shown in FIG. 1B, the edge touch sensor 160 in the stripe shape is disposed at the periphery of the left frame 10 and the periphery of the right frame 11.

FIG. 1C shows a schematic diagram of a mobile terminal 102 according to an exemplary embodiment of the present disclosure. As shown in FIG. 1C, a plurality of edge touch sensors 160 are evenly distributed at a region between a touch screen 13 of the terminal 102 and at least one frame of the terminal 102 in a discrete manner. For example, the edge touch sensors 160 are evenly distributed at a region 12 between the touch screen 13 and the left frame 10 and a region 14 between the touch screen 13 and the right frame 11 in a discrete manner.

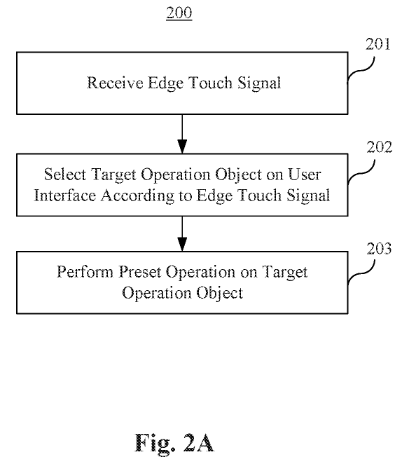

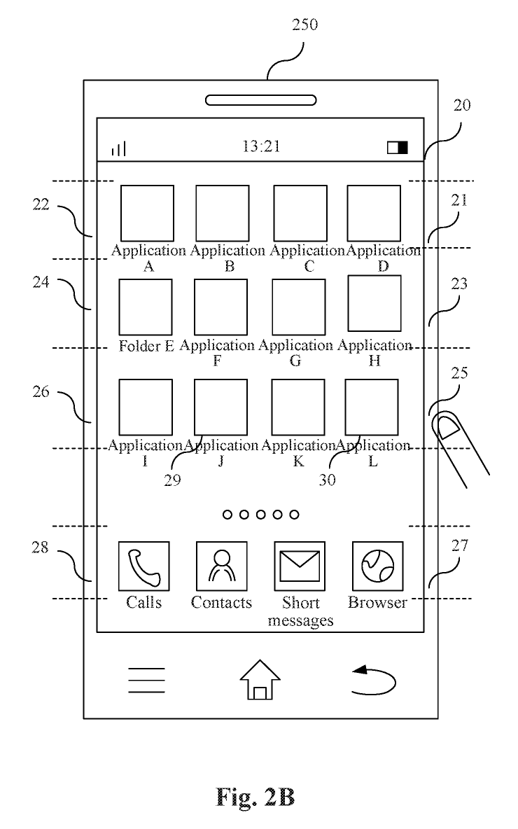

FIG. 2A is a flowchart showing a method 200 for operating an object on a user interface of a terminal, according to an exemplary embodiment of the present disclosure. The method 200 can be performed by any one of the mobile terminals 100, 101, or 102 described in connection with FIGS. 1A, 1B, and 1C, respectively. As shown in FIG. 2A, the method 200 for operating an object can include the following steps.

In step 201, an edge touch signal is received.

In step 202, a target operation object on a user interface is selected according to the edge touch signal.

The edge touch signal is a signal generated by an edge touch sensor when it senses a touch, and the user interface includes at least one operation object. In some embodiments, the at least one operation object can be any one of an application program, a folder, a file, a menu item, a grid and the like.

In some embodiments, the at least one operation object on the user interface can be arranged in rows and columns. Each row or column on the user interface can include a plurality of display regions arranged in order. The number of the operation objects can be smaller than the number of the display regions. For example, one operation object can correspond to one display region.

In some embodiments, different touch positions sensed by the edge touch sensors can correspond to different rows or columns on the user interface. The relationship between the edge touch sensors and the rows or columns of the display regions on the user interface is related to an actual physical structure of the mobile terminal.

FIG. 2B is a schematic diagram of a mobile terminal 250, according to an exemplary embodiment. As shown in FIG. 2B, sixteen operation objects Applications A-D and F-L, Folder E, Calls, Contacts, Short messages, and Browser are arranged in rows and columns on a user interface 20. Specifically, the operation objects are arranged in four rows. Each of the rows includes four display regions, i.e., four columns. Each display region has an operation object therein. Regions 21 and 22 correspond to four application programs, i.e., applications A-D, in the four display regions in the first row; regions 23 and 24 correspond to four application programs, i.e., Folder E and Applications F-H, in the four display regions in the second row; regions 25 and 26 correspond to four application programs, i.e., Applications I-L, in the four display regions in the third row; and regions 27 and 28 correspond to four application programs, i.e., Calls, Contacts, Short messages, and Bower in the four display regions in the fourth row.

In step 203, a preset operation is performed on the selected target operation object.

In the illustrated embodiment, in the method 200 for operating an object, an edge touch signal is received. A target operation object on a user interface is selected according to the edge touch signal. A preset operation is performed on the target operation object. When a user operates a mobile terminal having a large screen with one hand, the user may correctly select an object on the user interface displayed on the screen. By using the technical solutions in the present disclosure, a user can operate a mobile terminal with one hand, and user experience can be improved.

In an exemplary embodiment, before selecting of the target operation object on the user interface according to the edge touch signal, the mobile terminal can further determine whether a gesture (hereinafter “holding gesture”) of a user holding the mobile terminal is a preset holding gesture. The mobile terminal can obtain a holding gesture of the user and an edge touch signal by an edge touch sensor.

In some embodiments, after receiving an edge touch signal, the mobile terminal determines a holding gesture of the user via an edge touch sensor, and determines whether the holding gesture of the user is a preset holding gesture. If the holding gesture of the user is the preset holding gesture, the mobile terminal selects the target operation object on the user interface according to the received edge touch signal. After completing a response to an edge touch signal for the first time, in some embodiments, the mobile terminal acquires an edge touch signal and the holding gesture of the user again. The mobile terminal then determines whether the holding gesture is the preset holding gesture so as to determine whether to respond to the edge touch signal. If the holding gesture is not the preset holding gesture, the mobile terminal neglects the received edge touch signal. In other words, the mobile terminal does not respond to the received edge touch signal under such condition.

In some embodiments, after receiving the edge touch signal, the mobile terminal acquires the holding gesture of the user via the edge touch sensor. The mobile terminal determines whether the holding gesture of the user is a preset holding gesture. If the holding gesture of the user is the preset gesture, the mobile terminal may select the target operation object on the user interface without acquiring the holding gesture of the user in a subsequent period of time. If the holding gesture of the user is not the preset gesture, the mobile terminal obtains the holding gesture of the user again. The duration of the above-mentioned subsequent period of time can be measured in second, for example, five seconds, or ten seconds.

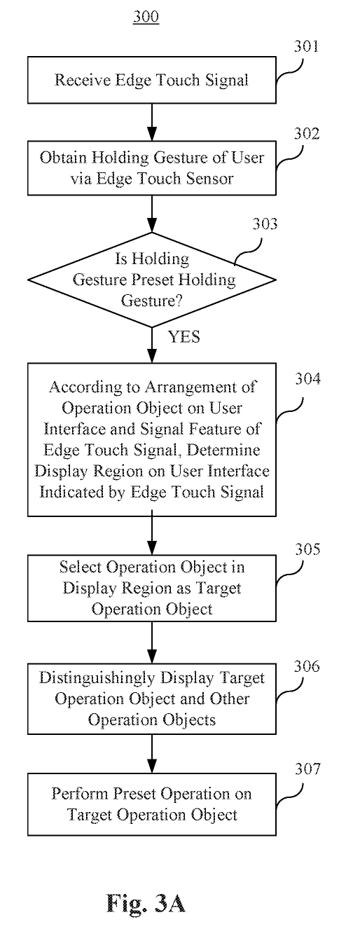

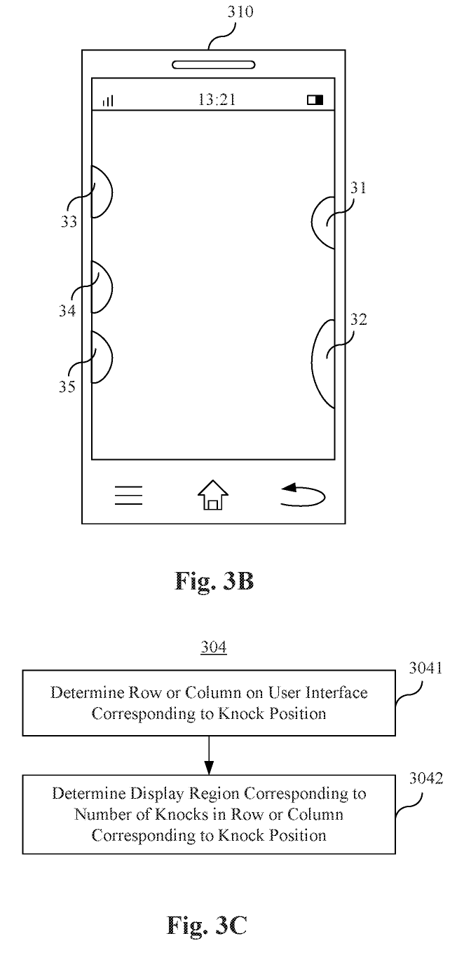

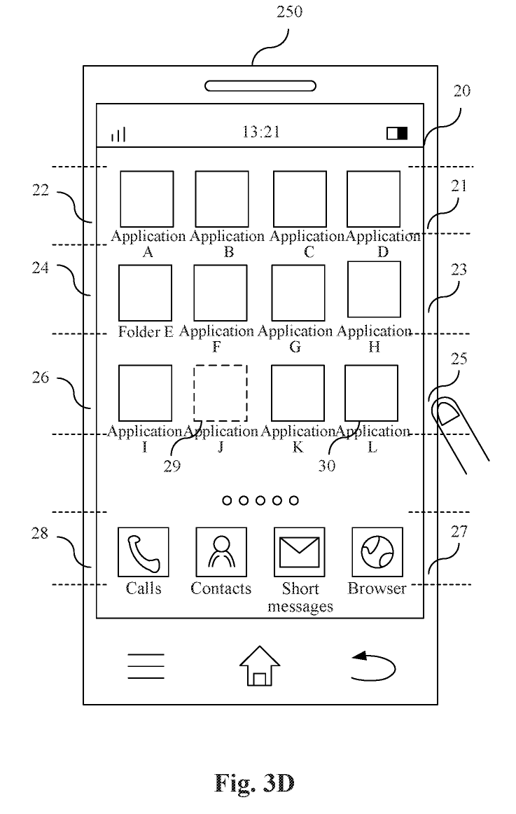

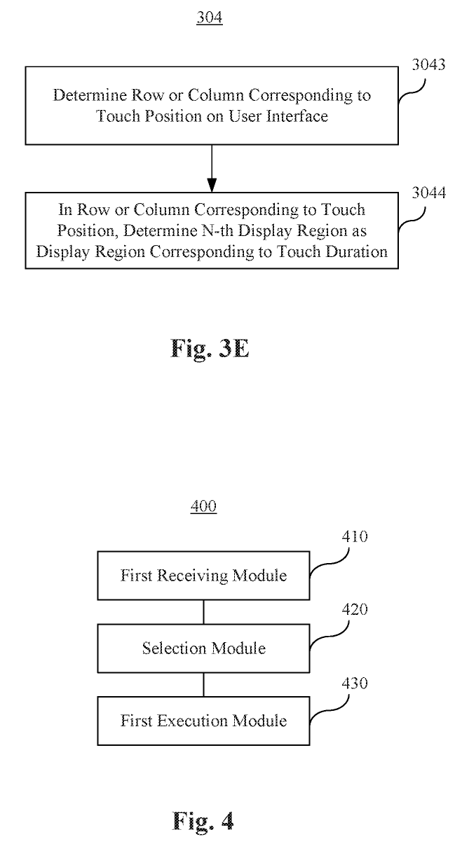

FIG. 3A is flowchart showing a method 300 for operating an object according to an exemplary embodiment of the present disclosure. The method 300 for operating an object can be performed any one of the mobile terminals 100, 101, and 102 described in connection with FIGS. 1A, 1B, and 1C, respectively. As shown in FIG. 3A, the method 300 can include the following steps.

In step 301, an edge touch signal is received.

Specifically, the mobile terminal receives an edge touch signal.

For example, when a user performs an operation at an edge of the mobile terminal, an edge touch signal can be generated.

It should be noted that the present embodiment does not impose limitations on a sequence of step 301. For example, step 301 can be performed after step 303.

In step 302, a holding gesture of the user holding the mobile terminal is obtained by an edge touch sensor.

For example, the mobile terminal can obtain the holding gesture of the user by an edge touch sensor.

Specifically, the holding gesture is a state for the user to use the mobile terminal. When the edge touch sensors on two opposite sides of the terminal sense at least four touch positions at the edges of the terminal, and at least one touch position is sensed at each side, the holding gesture of the user can be determined.

In step 303, whether the holding gesture is a preset holding gesture is determined.

In some embodiments, the preset holding gesture can be a one-handed holding gesture which is preset by the user. For example, after entering a setting interface of the mobile terminal, the user can hold the mobile terminal according to his/her operation habits, and the memory of the mobile terminal can store edge touch positions and the number of the edge touch positions when the user is using the preset holding gesture.

For example, the user can define the preset holding gesture as a right-handed gesture. FIG. 3B shows a mobile terminal 310 including touch positions located on a screen. As shown in FIG. 3B, the edge touch positions in the regions 31 to 35 constitute the edge touch positions on the mobile terminal being held by a user's right hand, corresponding to the preset holding gesture. For example, region 31 is a location where the thumb of the user's right hand touches the screen.

If the holding gesture of the user is the preset holding gesture, the mobile terminal performs the selection of the target operation object on the user interface according to the edge touch signal.

Specifically, if it is determined that the holding gesture is the preset holding gesture, the method 300 proceeds to step 304. If it is determined that the holding gesture is not the preset holding gesture, the mobile terminal neglects the received edge touch signal. In other words, the mobile terminal does not respond to the edge touch signal under such condition.

In step 304, according to an arrangement of the operation object on the user interface and a signal feature of the edge touch signal, a display region on the user interface indicated by the edge touch signal is determined.

In some embodiments, the edge touch signal includes an edge knock signal, and the signal feature of the edge touch signal includes a knock position and the number of knocks.

This step can be realized by the following two steps, as shown in FIG. 3C.

In step 3041, a row or a column on the user interface corresponding to the knock position is determined.

In step 3042, a display region corresponding to the number of knocks in the row or column corresponding to the knock position is determined.

The step can include: in the row or column corresponding to the knock position, determining a K-th display region as the display region corresponding to the number of knocks, wherein K=mod (M, N), M is the number of knocks, and N is the number of the display regions in the row or column corresponding to the knock position.

The number K is the remainder after dividing the number of knocks by the number of the display regions in the row or column corresponding to the knock position.

In some embodiments, the originating display region can be a preset display region. For example, the display region which is closest to the knock position can be set as the originating display region. Or one display region can be designated as the originating display region.

For example, in FIG. 2B, if a user's finger knocks at the region 25 for three times, the originating operation object is determined to be in display region 30 corresponding to the operation object “Application L,” because it is closest to the knock position, region 25. After receiving the edge touch signal, the mobile terminal determines that the knock position indicated by the edge touch signal is the region 25, that the number of the knocks is three, and that the knock position corresponds to the third row on the user interface. The mobile terminal determines a display region according to K=mod (3, 4)=3. That is, in the third row corresponding to the knock position, the third display region 29 from the right in the third row is determined to be the display region corresponding to the number of knocks because the originating display region is display region 30.

In step 305, the operation object in the determined display region is selected as the target operation object.

One operation object can correspond to one display region, so that the operation object in the display region indicated by the edge touch signal can be selected as the target operation object.

In step 306, the target operation object and other operation objects are distinctly displayed.

In some embodiments, the target operation object and other operation objects can be displayed with different background colors, different border effects, or different text effects.

In order to avoid undesired operations, the target operation object can be clearly shown. For example, the target operation object and other operation objects can be distinctly displayed.

In some embodiments, the background color of the target operation object can be modified. For example, the background color of the target operation object may be modified to look darker than those of unselected operation object(s).

In another embodiment, the icon boundary of the target operation object can have special effects. For example, the icon boundary of the target operation object can be blurred.

In another embodiment, the text effect of the target operation object can be changed. For example, the color of the name under the target operation object can be changed.

In another embodiment, the target operation object can be distinguished from other operation objects by at least one of changing the background color of the target operation object, generating special frame effects of the target operation object, or changing the text effect of the target operation object.

For example, if the “Application J” in the display region 29 in FIG. 2B is selected as the target operation object, the icon boundary of the “Application J” can become dotted line, as shown in FIG. 3D.

In some embodiments, if the distinctly displayed target operation object is the operation object as desired by the user, step 307 is performed. If the distinctly displayed target operation object is not the operation object desired by the user, edge touch operations are performed again and steps 301-306 may be performed to select a target operation object again.

In step 307, a preset operation is performed on the target operation object.

In some embodiments, if the target operation object is in a selected state for a preset period of time, the preset operation is automatically performed on the target operation object. For example, after the target operation object is in a selected state for one second, the preset operation is automatically performed.

In some embodiments, the preset operation can be opening, moving, deleting the target operation object and the like.

For example, when the target operation object is an application program, the preset operation can be opening the application program.

When the target operation object is a folder, the preset operation can be opening the folder.

When the target operation object is a file, the preset operation can be deleting the file.

In accordance with the above method 300, when a user has to operate a mobile terminal having a large screen with one hand, the user may correctly select an object on the user interface displayed on the screen. By using the technical solutions in the present disclosure, a user can operate a mobile terminal with one hand, and user experience can be improved.

In the illustrated embodiment, the mobile terminal may obtain a knock position indicated by the edge touch signal and the number of knocks to operate an operation object on a user interface with only one hand, and thus the user's operations of the mobile terminal become easier.

Further, in the illustrated embodiment, the target operation object and other operation objects may be distinctly displayed so that a user can easily be aware of incorrect selection of an operation object. Undesired operations can be avoided. Accordingly, the target operation object is more prominently shown, and undesired operations can be avoided to improve user experience.

In some embodiments, with reference to FIG. 3A, when the edge touch signal indicates a continuous touch, the signal feature of the edge touch signal in step 304 can include a touch position and a touch duration. The step 304 may further includes steps 3043 and 3044 as shown in FIG. 3E.

In step 3043, a row or column corresponding to the touch position on the user interface is determined.

In step 3044, in the row or column corresponding to the touch position, an n-th display region is determined as the display region corresponding to the touch duration.

The touch duration can be in direct proportion to n. The number n is the number of display regions in the row or column corresponding to the continuous touch signal.

The mobile terminal can obtain the touch position indicated by the edge touch signal and determine the row or column corresponding to the display region according to the touch position.

In some embodiments, the touch duration of the continuous touch signal can be in direct proportion to n. The proportional coefficient can be set by the user. For example, the proportional coefficient between the touch duration of the continuous touch signal and n is 1. When the duration of the continuous touch signal is 1 s (one second), the first display region, for example, from the right can be determined as the display region corresponding to the touch duration; when the duration of the continuous touch signal is 2 s (two seconds), the second display region from the right can be determined as the display region corresponding to the touch duration; when the duration of the continuous touch signal is 3 s (three seconds), the third display region from the right can be determined as the display region corresponding to the touch duration, and so on.

In some embodiments, the originating display region can be a preset display region. For example, the display region which is closest to the knock/touch position indicated by the edge touch signal can be set as the originating display region. Or one display region can be designated as the originating display region.

For example, with reference to FIG. 2B, if a user continuously touches the region 25 for 3 s (three seconds), the originating display region is the display region 30 which is closest to the touch position. The mobile terminal receives the edge touch signal, and determines that the touch position indicated by the edge touch signal is the region 25, that the continuous touch duration is three seconds, and that the continuous signal corresponds to the third row on the user interface. Assuming that the proportional coefficient between the touch duration and n is 1, the third display region 29 from the right in the third row can be determined as the display region corresponding to the touch duration.

According to the illustrated embodiment, when the user continuously touches the edge touch sensor, the mobile terminal can obtain the touch position indicated by the edge touch signal and the continuous touch duration. Accordingly, a user can operate operation objects on a user interface with one hand. Thus, the user operations of the mobile terminal become easier.

The present disclosure further provides embodiments of devices, which can implement the embodiments of the methods of the present disclosure. The detailed operations of the devices may be referred to the above descriptions of the method embodiments.

FIG. 4 is a block diagram showing a device 400 for operating an object according to an exemplary embodiment of the present disclosure. The device 400 for operating an object can be realized as whole or a part of a terminal which can provide the methods for operating an object by software, hardware or combination thereof. As shown in FIG. 4, the device 400 includes a first receiving module 410, a selection module 420, and a first execution module 430.

The first receiving module 410 is configured to receive an edge touch signal.

The selection module 420 is configured to select a target operation object on a user interface according to the edge touch signal. The edge touch signal is a signal generated by an edge touch sensor when it senses a touch. The user interface includes at least one operation object.

The first execution module 430 is configured to perform a preset operation on the target operation object.

In the illustrated embodiment, the device 400 receives an edge touch signal, selects a target operation object on a user interface according to the edge touch signal, and performs a preset operation on the target operation object. When a user has to operate a mobile terminal having a large screen with one hand, the user may correctly select an object on the user interface displayed on the screen. By using the technical solutions in the present disclosure, a user can operate a mobile terminal with one hand, and user experience can be improved.

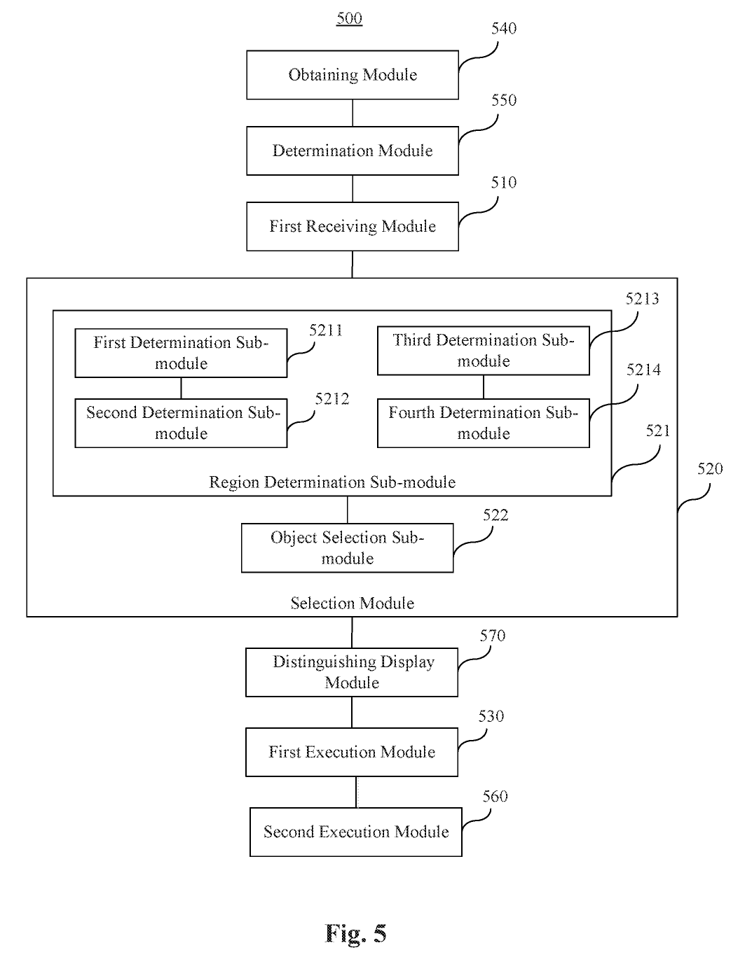

FIG. 5 is a block diagram showing a device 500 for operating an object according to an exemplary embodiment. The device 500 for operating an object can be realized as whole or a part of a mobile terminal which can provide the methods for operating an object by software, hardware or combination thereof. As shown in FIG. 5, the device 500 includes a first receiving module 510, a selection module 520, and a first execution module 530.

The first receiving module 510 is configured to receive an edge touch signal.

The selection module 520 is configured to select a target operation object on a user interface according to the edge touch signal. The edge touch signal is a signal generated by an edge touch sensor when it senses a touch. The user interface includes at least one operation object.

The first execution module 530 is configured to perform a preset operation on the target operation object.

In some embodiments, the selection module 520 includes a region determination sub-module 521 and an object selection sub-module 522.

The region determination sub-module 521 is configured to, according to an arrangement of the operation object on the user interface and a signal feature of the edge touch signal, determine a display region on the user interface indicated by the edge touch signal.

The object selection sub-module 522 is configured to select an operation object located in the indicated display region as the target operation object.

In some embodiments, the edge touch signal includes an edge knock signal, and the signal feature includes a knock position and the number of knocks.

The region determination sub-module 521 may include a first determination sub-module 5211 and a second determination sub-module 5212.

The first determination sub-module 5211 is configured to determine a row or a column on the user interface corresponding to the knock position. The at least one operation object on the user interface is arranged in at least one row and column. Each row or column includes a plurality of display regions arranged in order.

The second determination sub-module 5212 is configured to determine a display region corresponding to the number of knocks in the row or column corresponding to the knock position.

In some embodiments, the second determination sub-module 5212 is configured to, in the row or column corresponding to the knock position, determine a K-th display region as the display region corresponding to the number of knocks, wherein K=mod (M, N), M being the number of knocks and N being the number of the display regions in the row or column corresponding to the knock position.

In some embodiments, the edge touch signal includes a continuous touch signal, and the signal feature includes a touch position and a touch duration.

The region determination sub-module 521 may further include a third determination sub-module 5213 and a fourth determination sub-module 5214.

The third determination sub-module 5213 is configured to determine a row or column corresponding to the touch position on the user interface. The at least one operation object on the user interface is arranged in at least one row and column. Each row or column includes a plurality of display regions arranged in order.

The fourth determination sub-module 5214 is configured to, in the row or column corresponding to the touch position, determine an n-th display region as the display region corresponding to a touch duration. The touch duration may be in direct proportion to n.

In some embodiments, the device can further include an obtaining module 540, a determination module 550, and a second execution module 560.

The obtaining module 540 is configured to detect a holding gesture of a user via the edge touch sensor.

The determination module 550 is configured to determine whether the holding gesture is a preset holding gesture.

The second execution module 560 is configured to, if the holding gesture is the preset holding gesture, perform the selection of the target operation object on the user interface according to the edge touch signal.

In some embodiments, the device further includes a distinguishing display module 570.

The distinguishing display module 570 is configured to distinguishingly display the target operation object and other operation objects. The distinguishing module 570 can display the target operation object and other operation objects using at least one of different background colors, different border effects, or different text effects.

In accordance with the above device 500, when a user has to operate a mobile terminal having a large screen with one hand, the user may correctly select an object on the user interface displayed on the screen. By using the technical solutions in the present disclosure, a user can operate a mobile terminal with one hand, and user experience can be improved.

In the illustrated embodiment, the device 500 may obtain a knock position indicated by the edge touch signal and the number of knocks to operate an operation object on a user interface with only one hand, and thus the user's operations of the mobile terminal become easier.

In addition, the device 500 may sense a continuous touch on the edge touch sensor and obtain the touch position indicated by the edge touch signal and the continuous touch duration to determine a target operation object so that a user can operate operation objects on a user interface with one hand. Thus, the user's operations become easier.

Further, in the illustrated embodiment, the target operation object and other operation objects may be distinctly displayed so that a user can easily be aware of incorrect selection of an operation object. Undesired operations can be avoided. Accordingly, the target operation object is more prominently shown, and undesired operations can be avoided to improve user experience.

With respect to the devices 400 and 500 in the above embodiments, the specific manners for performing operations for individual modules therein have been described in detail in the embodiments regarding the methods, which will not be elaborated herein.

An exemplary embodiment of the present disclosure provides a device for operating an object, which is capable of implementing the methods for operating an object provided by the present disclosure. The device for operating an object can include: a processor; and a memory for storing instructions executable by the processor; wherein the processor is configured to: receive an edge touch signal; select a target operation object on a user interface according to the edge touch signal, wherein the edge touch signal is a signal generated by an edge touch sensor when it sense a touch, and the user interface includes at least one operation object; and perform a preset operation on the target operation object.

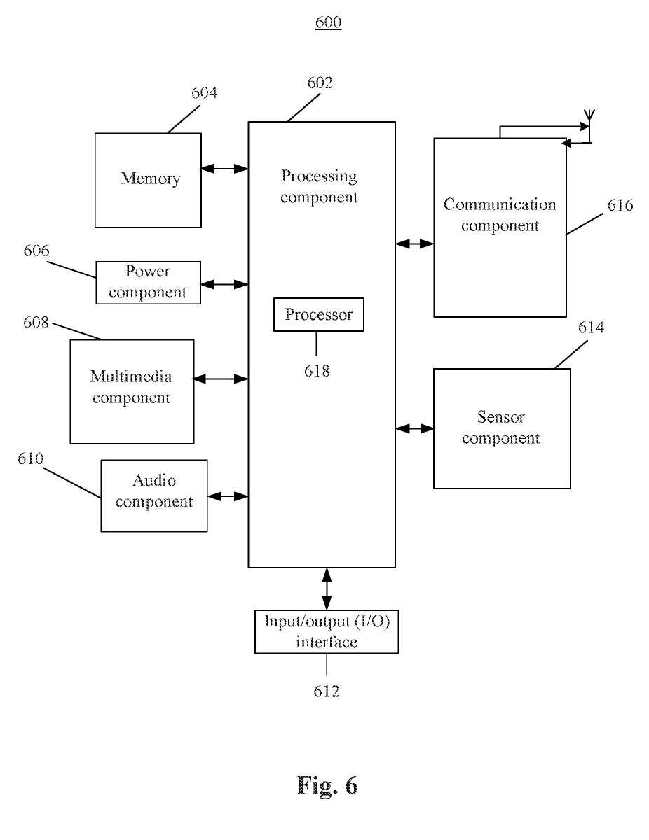

FIG. 6 is a block diagram showing a device 600 for operating an object according to an exemplary embodiment. For example, the device 600 may be a mobile terminal described above and may be a mobile phone, a computer, a digital broadcast terminal, a messaging device, a gaming console, a tablet, a medical device, exercise equipment, a personal digital assistant, and the like.

Referring to FIG. 6, the device 600 may include one or more of the following components: a processing component 602, a memory 604, a power component 606, a multimedia component 608, an audio component 610, an input/output (I/O) interface 612, a sensor component 614, and a communication component 616.

The processing component 602 typically controls overall operations of the device 600, such as the operations associated with display, telephone calls, data communications, camera operations, and recording operations. The processing component 602 may include one or more processors 618 to execute instructions to perform all or part of the steps in the above described methods. Moreover, the processing component 602 may include one or more modules which facilitate the interaction between the processing component 602 and other components. For instance, the processing component 602 may include a multimedia module to facilitate the interaction between the multimedia component 608 and the processing component 602.

The memory 604 is configured to store various types of data to support the operation of the device 600. Examples of such data include instructions for any applications or methods operated on the device 600, contact data, phonebook data, messages, pictures, video, etc. The memory 604 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 606 provides power to various components of the device 600. The power component 606 may include a power management system, one or more power sources, and any other components associated with the generation, management, and distribution of power in the device 600.

The multimedia component 608 includes a screen providing an output interface between the device 600 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 608 includes a front camera and/or a rear camera. The front camera and the rear camera may receive an external multimedia datum while the device 600 is in an operation mode, such as a photographing mode or a video mode. Each of the front camera and the rear camera may be a fixed optical lens system or have focus and optical zoom capability.

The audio component 610 is configured to output and/or input audio signals. For example, the audio component 610 includes a microphone (“MIC”) configured to receive an external audio signal when the device 600 is in an operation mode, such as a call mode, a recording mode, and a voice recognition mode. The received audio signal may be further stored in the memory 604 or transmitted via the communication component 616. In some embodiments, the audio component 610 further includes a speaker to output audio signals.

The I/O interface 612 provides an interface between the processing component 602 and peripheral interface modules, such as a keyboard, a click wheel, buttons, and the like. The buttons may include, but are not limited to, a home button, a volume button, a starting button, and a locking button.

The sensor component 614 includes one or more sensors to provide status assessments of various aspects of the device 600. For instance, the sensor component 614 may detect an open/closed status of the device 600, relative positioning of components, e.g., the display and the keypad, of the device 600, a change in position of the device 600 or a component of the device 600, a presence or absence of user contact with the device 600, an orientation or an acceleration/deceleration of the device 600, and a change in temperature of the device 600. The sensor component 614 may include a proximity sensor configured to detect the presence of nearby objects without any physical contact. The sensor component 614 may also include a light sensor, such as a CMOS or CCD image sensor, for use in imaging applications. In some embodiments, the sensor component 614 may also include an accelerometer sensor, a gyroscope sensor, a magnetic sensor, a pressure sensor, or a temperature sensor.

The communication component 616 is configured to facilitate communication, wired or wirelessly, between the device 600 and other devices. The device 600 can access a wireless network based on a communication standard, such as WiFi, 3G or 4G or a combination thereof. In one exemplary embodiment, the communication component 616 receives a broadcast signal or broadcast associated information from an external broadcast management system via a broadcast channel. In one exemplary embodiment, the communication component 616 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 600 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods for operating an object.

In an exempalry embodiment, there is also provided a non-volatile computer readable storage medium which includes instructions, for example, the memroy 604 including instructions, and the instructions can be executed by the processor 618 in the device 600 to realize the above methods for operating an object. For examlpe, the non-volatile computer readable storage medium can be an ROM, a read-only memory (ROM), a CD-ROM, a magnetic tape, a soft disk, an optical data storage device and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for operating an object on a mobile terminal, comprising:
receiving an edge touch signal generated by an edge touch sensor of the mobile terminal;
selecting a target operation object on a user interface of the mobile terminal according to the edge touch signal, wherein the user interface includes at least one operation object; and
performing a preset operation on the target operation object.

2. The method according to claim 1, wherein the selecting of the target operation object on the user interface according to the edge touch signal, comprises:
according to an arrangement of the at least one operation object on the user interface and a signal feature of the edge touch signal, determining a display region on the user interface indicated by the edge touch signal; and
selecting an operation object located in the determined display region as the target operation object.

3. The method according to claim 2, wherein the edge touch signal includes an edge knock signal, and the signal feature includes a knock position and a number of knocks;
wherein the determining of the display region on the user interface indicated by the edge touch signal according to the arrangement of the at least one operation object on the user interface and the signal feature of the edge touch signal, comprises:
determining a row or a column on the user interface corresponding to the knock position, wherein the at least one operation object on the user interface is arranged in at least one row and column, and each row or column includes a plurality of display regions arranged in order; and
determining a display region corresponding to the number of knocks in the row or column corresponding to the knock position.

4. The method according to claim 3, wherein the determining of the display region corresponding to the number of knocks in the row or column corresponding to the knock position, comprises:
in the row or column corresponding to the knock position, determining a K-th display region as the display region corresponding to the number of knocks,
wherein K=mod (M, N), M is the number of knocks, and N is a number of display regions in the row or column corresponding to the knock position.

5. The method according to claim 2, wherein the edge touch signal includes a continuous touch signal, and the signal feature includes a touch position and a touch duration;
wherein the determining of the display region on the user interface indicated by the edge touch signal according to the arrangement of the operation object on the user interface and the signal feature of the edge touch signal, comprises:
determining a row or column corresponding to the touch position on the user interface, wherein the at least one operation object on the user interface is arranged in at least one row and column, and each row or column includes a plurality of display regions arranged in order; and
in the row or column corresponding to the touch position, determining an n-th display region as the display region corresponding to the touch duration, wherein the touch duration is in direct proportion to n.

6. The method according to claim 1, further comprising:
determining, via the edge touch sensor, a holding gesture of a user holding the mobile terminal ;
determining whether the holding gesture is a preset holding gesture; and
if the holding gesture is the preset holding gesture, performing the selection of the target operation object on the user interface according to the edge touch signal.

7. The method according to claim 1, further comprising:
displaying the target operation object distinctly from a second operation object, wherein the target operation object and the second operation object are displayed using at least one of different background colors, different border effects, or different text effects.

8. A device for operating an object, comprising:
a processor; and
a memory for storing instructions executable by the processor;
wherein the processor is configured to:
receive an edge touch signal generated by an edge touch sensor of the mobile terminal;
select a target operation object on a user interface according to the edge touch signal, wherein the user interface includes at least one operation object; and
perform a preset operation on the target operation object.

9. The device according to claim 8, wherein the processor is further configured to:
according to an arrangement of the at least one operation object on the user interface and a signal feature of the edge touch signal, determine a display region on the user interface indicated by the edge touch signal; and
select an operation object located in the determined display region as the target operation object.

10. The device according to claim 9, wherein the edge touch signal includes an edge knock signal, and the signal feature includes a knock position and a number of knocks; and
wherein the processor is further configured to:
determine a row or a column on the user interface corresponding to the knock position, wherein the at least one operation object on the user interface is arranged in at least one row and column, and each row or column includes a plurality of display regions arranged in order; and
determine a display region corresponding to the number of knocks in the row or column corresponding to the knock position.

11. The device according to claim 10, wherein the processor is further configured to:
in the row or column corresponding to the knock position, determine a K-th display region as the display region corresponding to the number of knocks, wherein K=mod (M, N), M is the number of knocks, and N is a number of display regions in the row or column corresponding to the knock position.

12. The device according to claim 9, wherein the edge touch signal includes a continuous touch signal, and the signal feature includes a touch position and a touch duration; and
wherein the processor is configured to:
determine a row or column corresponding to the touch position on the user interface, wherein the at least one operation object on the user interface is arranged in at least one row and column, and each row or column includes a plurality of display regions arranged in order; and
in the row or column corresponding to the touch position, determine an n-th display region as the display region corresponding to the touch duration, wherein the touch duration is in direct proportion to n.

13. The device according to claim 8, wherein the processor is further configured to:
determine, via the edge touch sensor, a holding gesture of a user holding the device;
determine whether the holding gesture is a preset holding gesture; and
if the holding gesture is the preset holding gesture, perform the selection of the target operation object on the user interface according to the edge touch signal.

14. The device according to claim 8, wherein the processor is further configured to:
displaying the target operation object distinctly from a second operation object, wherein the target operation object and the second operation object are displayed using at least one of different background colors, different border effects, or different text effects.

15. A non-transitory computer-readable storage medium having stored therein instructions that, when executed by a processor of a mobile terminal, cause the mobile terminal to perform a method for operating an object, the method comprising:
receiving an edge touch signal generated by an edge touch sensor of the mobile terminal;
selecting a target operation object on a user interface of the mobile terminal according to the edge touch signal, wherein the user interface includes at least one operation object; and
performing a preset operation on the target operation object.
